(19) United States
(12) Patent Application Publication
(10) Pub. No.: US 2012/0043937 A1
(43) Pub. Date: Feb. 23, 2012

(54) CHARGER FOR ELECTRONIC DEVICES HAVING A RECHARGEABLE BATTERY

(76) Inventor: JAMAAL WILLIAMS, Montgomery, AL (US)

(21) Appl. No.: 12/860,423

(22) Filed: Aug. 20, 2010

(51) Int. Cl. H02J 7/00

(52) U.S. Cl. 320/115; 320/114

(57) ABSTRACT

A charger includes a pouch sized to receive an electronic device therewithin. A charger circuit and at least one battery are disposed within the pouch for recharging a battery of the electronic device. Electrical contacts are mounted for access within the hollow interior of the pouch and/or on the exterior surface thereof. At least one contact assembly is provided and has a set of mating contacts and a power socket. Audio and visual annunciation is also provided for annunciating power levels of the electronic device. The charger may also include a cradle and another socket for charging a hands-free accessory operating on a Bluetooth wireless protocol. The charger may additionally include fasteners or hollow sleeves for adjusting the usable portion of the hollow interior.

### FIELD OF THE INVENTION

The present invention relates, in general, to charging devices and, more particularly, this invention relates to a charger for electronic devices having a rechargeable battery and, yet particularly, the instant invention relates to a wearable charger for mobile phone and associated hands-free accessory operating on a Bluetooth protocol and to a charger for portable computers.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, use of electronic devices proliferated in recent years to a point where a person may carry plurality of devices each designated to provide a particular function. For example, a person may carry a cell (mobile) phone for voice transmissions, a music playing device and a computer and may use at least two devices simultaneously. As is further generally well known, any electronic device heavily depends on internal rechargeable battery as a main source for providing necessary power. However, presently used batteries have a limited operating life before requiring recharging. Thus, many are constantly looking for a conventional wall outlet or a 12-volt automotive power outlet to recharge the battery or are forced to carry a spare battery. A particular disadvantage is felt by those who desire to use electronic devices for extended periods of times while away from the convenience or presence of electrical outlets.

### SUMMARY OF THE INVENTION

The invention provides a charger for mobile communication devices. The charger includes a pouch. The pouch has a front wall, a rear wall, a pair of side walls and a bottom wall defining in combination a hollow interior and an open end disposed in operative communication with the hollow interior. There is a generally closed chamber that is disposed adjacent at least one wall of the pouch. At least one, and preferably a pair of batteries disposed within the generally closed chamber. A power input port is disposed within the generally closed chamber and accessible for entry from an exterior of the pouch. A power output port may be also disposed within the generally closed chamber and accessible for entry from the exterior of the pouch. A charging circuit is electrically coupled to the power input port and to the at least one battery. At least one set of first electrical conductors is provided for access within the hollow interior or on an exterior surface of the pouch and electrically coupled to the charging circuit. There is also at least one contact assembly having each of a body, a set of second electrical conductors sized and shaped to operatively and releaseably mate with the at least one set of first electrical conductors, and a power plug extending above a surface of the body. The power plug is electrically coupled to the set of second electrical conductors and sized and shaped to operatively engage a power socket of the mobile electronic device. The at least one contact assembly is dimensioned so that when the sets of first and second electrical conductors are operatively mated therebetween the power plug is positioned to operatively engage the power socket of the mobile electronic device. A control circuit is also provided. The pouch may be adapted with a member for attachment to article of clothing or a carrying bag or with carrying handles. The pouch may also have internal fasteners or sleeves for adjusting the hollow interior portion to operatively mate with electronic device of a specific size. An exterior cradle with a charging plug may be also provided for charging a mobile phone accessory operating on a Bluetooth protocol.

### OBJECTS OF THE INVENTION

It is, therefore, one of the primary objects of the present invention to provide a charger for electronic devices having a rechargeable battery.

Another object of the present invention is to provide a charger for electronic devices that contains a pair of batteries.

Yet another object of the present invention is to provide a charger for electronic devices that is constructed from a shock-resistant material.

A further object of the present invention is to provide a charger for electronic devices that annunciates charging status of the electronic device.

Yet a further object of the present invention is to provide a charger for electronic devices that can be attached to article of clothing or a carrying bag.

Another object of the present invention is to provide a charger for electronic devices that has adjustable inner portion to fit electronic devices of variable sizes.

Yet a further object of the present invention is to provide a charger for electronic devices that is capable of also charging a wirelessly operated accessory.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 illustrates an isometric view of a charger of the instant invention;

FIG. 2 illustrates an isometric view of a connector assembly employed in combination with the charger of FIG. 1;

FIG. 3 illustrates a side elevation view of the charger of FIG. 1;

FIG. 4 is a partial isometric view of the charger of FIG. 1 having a cradle for charging an accessory operating on a Bluetooth wireless protocol;

FIG. 5 illustrates a block diagram of the charger of FIG. 1;

FIG. 6 illustrates front elevation view of the charger of FIG. 1 adapted with means for adjusting usable portion of the hollow interior; and

FIG. 7 illustrates front elevation view of the charger of FIG. 1 adapted with another means for adjusting usable portion of the hollow interior.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

The present invention provides a pouch containing a charger circuit and at least one battery for recharging a battery of an electronic device and annunciation means for annunciating power levels of the electronic device.

It is to be understood that the definition of an electronic device includes but is not limited to mobile phones, pagers, mp3 players, portable computers, notebook computers, Ipads® and the like devices.

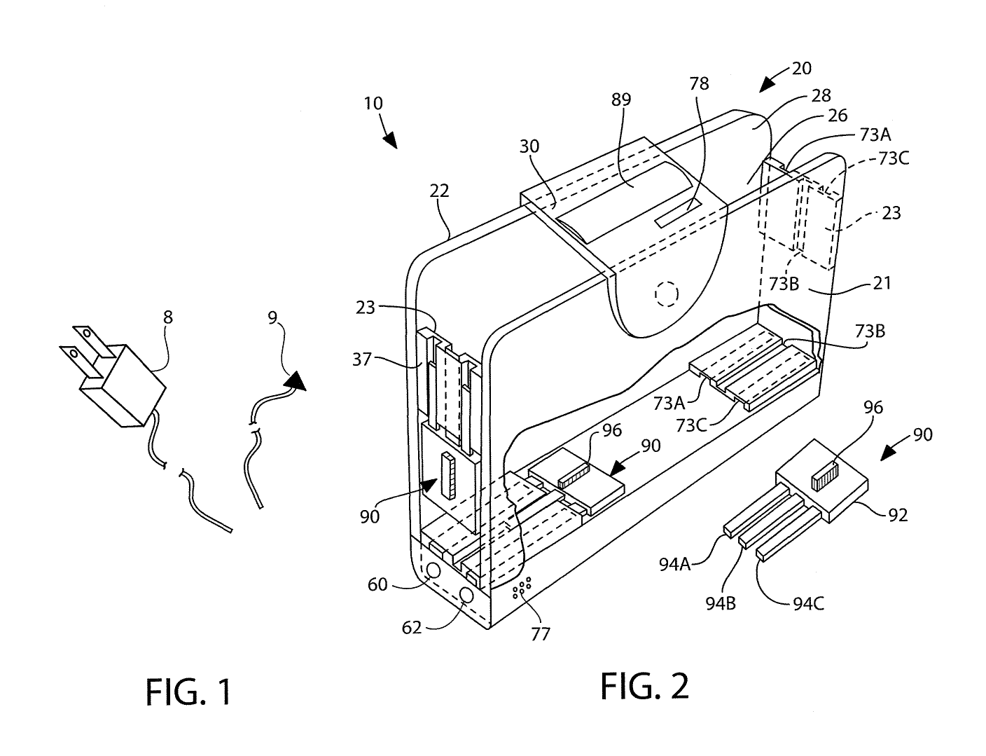

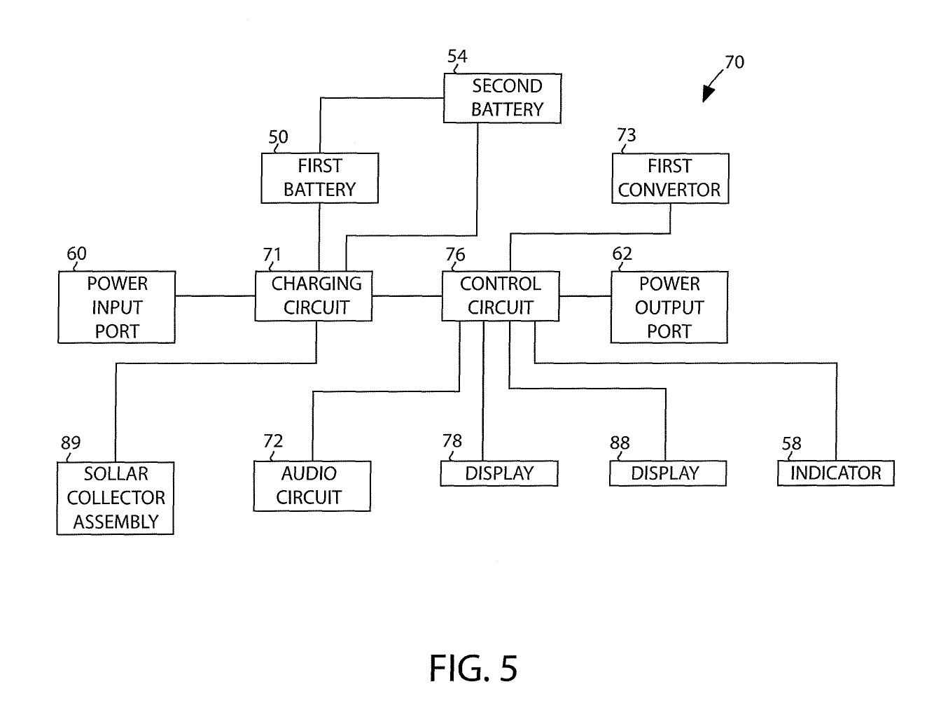

Reference is now made, to FIGS. 1-7, wherein there is shown a charger, generally designated as 10, for charging an electronic device 2 having a rechargeable battery. The charger 10 includes a pouch 20 having each of a front wall 21, a rear wall 22, a pair of side walls 23 and a bottom wall 25 defining in combination each of a hollow interior 26 and an open end 28 disposed in operative communication with the hollow interior 26. Preferably, the side walls 26 are in a shape of a strap disposed mediate the bottom wall 25 and the open end 28. The wearable pouch 20 is preferably manufactured from at least one of a shock resistant and liquid impermeable material. The hollow interior 26 of the pouch 20 may be sized so as to positively retain the electronic device therewithin (for example by way of a frictional fit) and prevent unintentional separation of the electronic device 2 therefrom, however means for closing the open end 28 may be also provided. By way of an example only of FIG. 1, such means is shown as a flap 30 that may be advantageous when the electronic device 2 is a mobile phone or the like mobile communication device. The flap 30 is attached to or formed integral with a free upper edge of one wall, shown as the rear wall 22, of the pouch 20 in operative positioning with the open end 28. The flap 30 pivots between a first position for at least partially closing the open end 28 so as to retain electronic device 2 within the hollow interior 26 and a second position for opening the open end 28 so that the electronic device 2 can be easily removed from the hollow interior 26 or inserted thereinto.

There is means for releaseably securing the flap 30 in the first position. Preferably, such releaseably securing means is a pair of magnets, wherein a first magnet 32 is secured to one of a front exterior surface 27 of a front wall 21 of the pouch 20 and an inner surface of the flap 30 and wherein the second magnet 34 is secured to an opposed one of the front exterior surface 27 of the pouch 20 and the inner surface of the flap 30. Alternatively, such retaining means may be a clasp, a loop and hook fastener or any other suitable means.

When the electronic device 2 is the mobile phone or the like mobile communication device, it is presently preferred to attach the charger 10 to one of a limb, article of clothing, clothing accessory and carrying bag. Thus, a member is secured to an exterior surface 29 of the rear wall 22 of the pouch 20 and is dimensioned and shaped so as to attach the pouch 20 to such one of a limb, article of clothing, clothing accessory and carrying bag. By way of an example only, such member shown in FIG. 2 as a generally U-shaped spring clip 34 that is attached to the rear surface 29 by way of a conventional swivel 36.

Also provided is a generally closed chamber 40. Such generally closed chamber 40 is defined by a combination of a cover portion 42 and either an exterior or interior surface of one of the walls of the pouch 20. Such generally closed chamber 40 is best shown in FIGS. 1-2 as being disposed adjacent the bottom wall 25, however it is within the scope of the instant invention to locate such chamber 40 along any other wall of the pouch 20.

A first battery 50 is disposed within the chamber 40 and is employed for charging the electronic device 2. A second battery 54 is also disposed within the chamber 40 and is electrically coupled to each of the first battery 50 and the supply power. The second battery 54 collects the supply power and distributes it to the first battery 50 except for a small portion of such supply power which is retained (stored) within the second battery 54. An access to the batteries 50 and 54 may be also provided by way of a removable cover(s) 56.

There is an input port 60 and an output port 62, both disposed within the chamber 40 and accessible from the exterior surface of the pouch 20, shown as the side exterior surface 31 but that can be any other surface. An input port 60 is employed for receiving the supply power, by way of a plug 8 from a remote power source which may be a conventional electric outlet, by way of a plug 9 from a 12-Volt vehicle power supply, power adapter (not shown) and the like power sources. It would be appreciated that the type of the input port 60 will be selected depending on particular application requirements. The present invention contemplates that the input port 60 may be configured to receive power from the electronic device, such as a computer (not shown) by way, for example, of a Universal Serial Bus (USB).

It is also within the scope of the present invention to provide a plurality of input ports 60, each configured to receive power from a distinct power source. Likewise, the type of the output port 62 is selected depending on particular application requirements and the instant invention contemplates use of more than one output port 62.

A control circuit assembly 70 is at least partially disposed within the chamber 40. The control circuit assembly 70 includes at least a charging circuit 71 electrically coupled to at least one of the first and second batteries, 50 and 54 respectively. The control circuit 70 assembly may further include at least one indicator 58 that is operable to indicate charge levels of the first battery 50 and/or second battery 54.

Also provided is an audio circuit 72 which is electrically coupled to the control circuit 76 and which is configured to emit a predetermined sound through the grille arrangement 77 and/or generate vibration for the purposes of annunciating the charging condition of the electronic device 2. Such sound may be also a voice. The charging condition may be annunciated incrementally or when the maximum charging level is achieved. The control circuit 76 is preferably of a microprocessor type

At least one set of first electrical conductors 73 (including three conductors 73A, 73B and 73C) is provided in the pouch 20 and is electrically coupled to the control circuit 76.

A display 78 is preferably integrated into a portion of the flap 30 and is operable to incrementally display charging status of such electronic device 2. The display 78 may be of a liquid crystal display (LCD) type. It would be appreciated that electrical connection between the display 78 and the control circuit assembly 70 would be hidden within the thickness of the flap 30 and the rear wall 22.

It is also within the scope of the present invention to provide means, generally designated 80, for recharging a hands-free accessory 4 (operating on a Bluetooth protocol) for the electronic device 2, such as the mobile phone.

Such means 80 includes a retaining means, such as a cradle 82, disposed preferably on an exterior front surface 27 of the front wall 21 of the pouch 20 and sized and shaped for receiving and releasably retaining a communication device 4 operating on a Bluetooth protocol. Means, such as a power socket 84, is provided within the cradle 82 for charging such Bluetooth communication device 4 received therewithin. A second display 88 for incrementally displaying charging status of such Bluetooth communication device 4 may be also provided.

The present invention also contemplates the use of an optional solar collector assembly 89 disposed on the portion of the flap 30 that spans the open end 28 of the pouch 20 and that arranged to harvest solar power and convert it into electric power for charging the batteries 50 and 54 through the charging circuit 71.

The instant invention advantageously provides for charging the electronic device 2 either received within the pouch 20 or disposed external thereto as well as provides for charging plurality of electronic devices 2. Accordingly, the charger 10 includes a predetermined plurality of first conductor sets 73 disposed both within the hollow interior 26 as well as on the exterior surface of the pouch 20. Now in further reference to FIG. 1, one pair of such first conductor sets 73 is mounted on the inner surface of the bottom wall 25 and another pair of such first conductor sets 73 is mounted on the exterior surface 24 of each side wall 23.

Although, the first conductor sets 73 may be configured for direct engagement with the power socket of the electronic device 2, a contact assembly, generally designated as 90, is provided and is best shown in FIG. 2. The contact assembly 90 has each of a body 92, a set of second electrical conductors 94 (including three conductors 94A, 94B and 94C) sized and shaped to operatively and releaseably mate with the at least one set of first electrical conductors 73, and a power plug 96 extending above a surface of the body 92. The power plug 96 is electrically coupled to the set of second electrical conductors 94 and is sized and shaped to operatively engage a power socket of the electronic device 2. The contact assembly 90 is dimensioned so that when the sets of first and second electrical conductors are operatively mated therebetween, the power plug 96 is positioned to operatively engage the socket of the electronic device 2.

The first and second electrical conductors are shown as elongated prongs, although other conventional plug/socket arrangements may be employed within the instant invention. Furthermore, the inside electrical conductor 73B and 94B are disposed in a plane that is offset from the plane of the other conductors 73A, 73C and 94A, 94C respectively so as to provide positive interlocking during use.

Although, one contact assembly 90 may be employed, a plurality of contact assemblies 90 is also contemplated, each configured, at the power plug 96, to charge a specific electronic device 2.

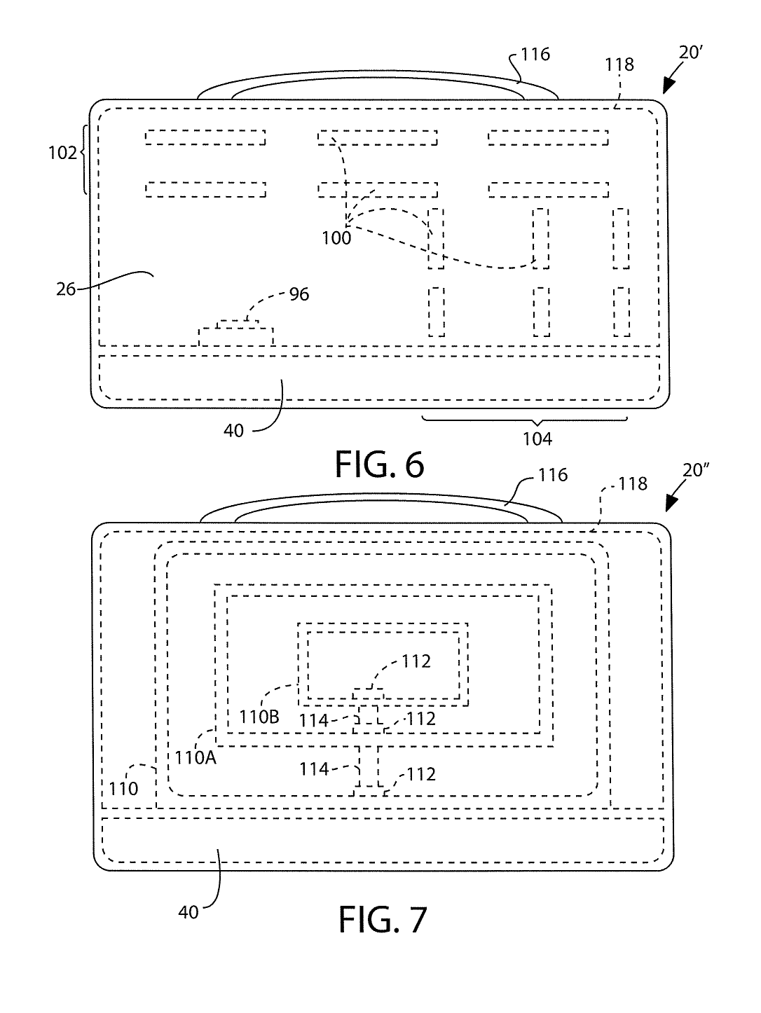

FIG. 6 illustrates the pouch 20′ configured to operatively receive electronic devices 2 of various sizes in a manner that minimizes movement of such electronic device 2 within the hollow interior 26. Accordingly, the pouch 20′ may be adapted with means for adjusting usable portion of the hollow interior 26, such as fasteners 100, secured in operative alignment to the inner surfaces of the front wall 21 and rear wall 22 and arranged in a pattern defining plurality of rows 102 and columns 104. The fasteners 100 are shown as hook and loop fasteners 100, but may be also provided as clasps, buttons, zippers and the like fasteners. The columns 104 are positioned at pre-selected distances from the side wall 23 having the set of conductors 73 disposed adjacent thereto and rows 102 are positioned at preselected distances from the bottom wall 25. Thus, to adjust the size of the interior 26 of the pouch 20, the user simply selects the appropriate row 102 and appropriate column 104 according to the size of the electronic device 2. The means for closing the open end 28 of the pouch 20′ may be then provided as a conventional zipper 118 and the pouch 20′ may be further adapted with carrying handles 116.

It is also contemplated, as shown in FIG. 7, that such means for adjusting usable portion of the hollow interior 26 may include a plurality of hollow sleeves 110, 110A, 110B, 110C nested within each other and disposed within said hollow interior 26 of the pouch 20″, each of the plurality of hollow sleeves 110, 110A, 110B, having a power plug 112 coupled to each of the charging circuit 71 and to one of a power socket of the electronic device 2 and a power socket 114 of an adjacent hollow sleeve. The means for closing the open end 28 of the pouch 20″ may be then provided as a conventional zipper 118 and the pouch 20″ may be further adapted with carrying handles 116.

To charge a brand new charger 10 or recharge the charger 10 after use, the user simply connects the charger 10 to a conventional wall outlet or car outlet (not shown) through the input power port 60 or exposes the charger 10 equipped with the solar collector assembly 89 to light.

When the batteries 50 and 54 are charged, the user mounts the contact assembly 90 at a predetermined position on or within the pouch 20 and simply connects the electronic device 2 to the power plug 96.

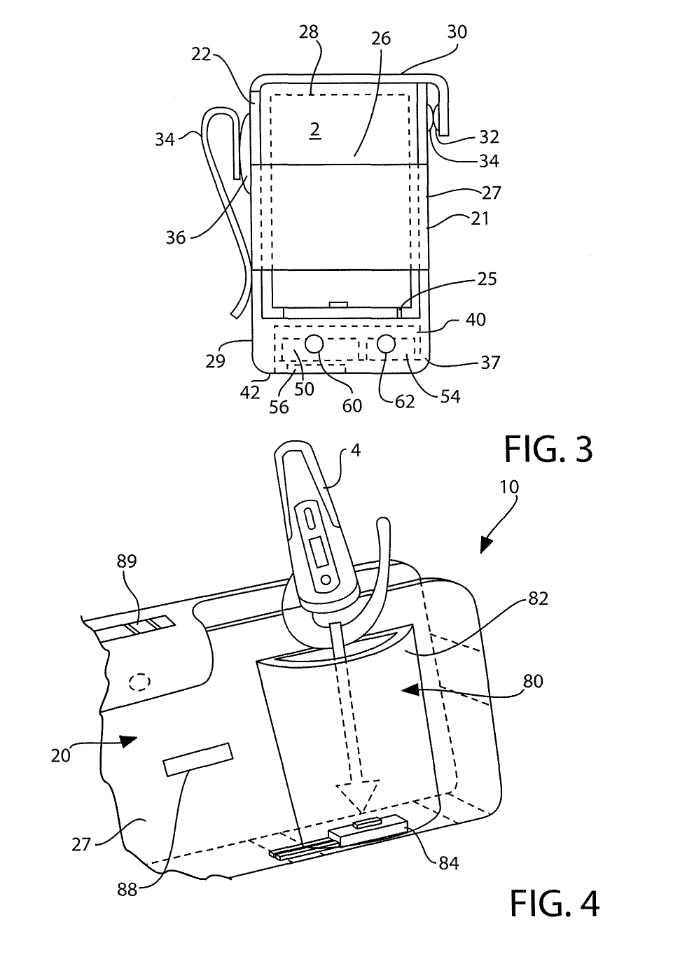

When the electronic device 2 is received for charging within the hollow interior 26, as best shown in FIG. 3, the user of the electronic device 2 is benefited by operating the electronic device 2 for prolong periods in conditions prohibiting access to conventional source of electrical power, for example, such as jogging, hiking, air travel, farming and the like activities.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with an electronic device having a rechargeable battery a battery charger comprising:
(a) a pouch having each of a front wall, a rear wall, a pair of side walls and a bottom wall defining in combination a hollow interior and an open end disposed in operative communication with said hollow interior;
(b) a generally closed chamber disposed adjacent at least one wall of said pouch;
(c) at least one battery disposed within said generally closed chamber;
(d) a power input port disposed within said generally closed chamber and accessible for entry from an exterior of said pouch;
(e) a charging circuit electrically coupled to said power input port and to said at least one battery;
(f) at least one set of first electrical conductors provided for access within said hollow interior or on an exterior surface of said pouch and electrically coupled to said charging circuit;
(g) at least one contact assembly having each of a body, a set of second electrical conductors sized and shaped to operatively and releaseably mate with said at least one set of first electrical conductors, and a power plug extending above a surface of said body, said power plug electrically coupled to said set of second electrical conductors and sized and shaped to operatively engage a power socket of the mobile electronic device, said at least one contact assembly is dimensioned so that when said sets of first and second electrical conductors are operatively mated therebetween said power plug is positioned to operatively engage the power socket of the mobile electronic device; and
(h) a control circuit.

2. The charger of claim 1, further including a flap attached to or formed integral with a distal edge of one wall of said pouch in operative positioning with said open end, said flap pivotal between a first position for at least partially closing said open end and an open position for opening said open end.

3. The charger of claim 2, further including means for releaseably securing said flap in said first position.

4. The charger of claim 1, further including means for adjusting usable portion of said hollow interior.

5. The charger, according to claim 4, wherein said means for adjusting usable portion of said hollow interior includes a plurality of fasteners secured in operative alignment to interior surfaces of each of said front and rear walls and arranged in a pattern defining each of plurality of columns and plurality of rows.

6. The charger, according to claim 4, wherein said means for adjusting usable portion of said hollow interior includes a plurality of hollow sleeves nested within each other and disposed within said hollow interior of said pouch, each of said plurality of hollow sleeves having a power plug coupled to each of said charging circuit and to one of a power socket of the electronic device and a power socket of an adjacent hollow sleeve.

7. The charger of claim 1, further including another battery disposed within said generally closed chamber, said another battery electrically coupled to said at least one battery.

8. The charger of claim 1, further including a power output port disposed within said generally closed chamber and coupled to said battery, said power output accessible for entry from said exterior of said pouch.

9. The charger of claim 1, further including an audio circuit having means for generating vibration.

10. The charger of claim 1, further including means for annunciating charged condition of the electronic device.

11. The charger of claim 1, further including a display means for incrementally displaying charging status of the electronic device.

12. The charger of claim 1, further including a cradle disposed on an exterior surface of one wall of said pouch, said cradle sized and shaped to receive therein a hands-free communication device operating on a Bluetooth wireless protocol.

13. The charger of claim 12, further including means for charging the Bluetooth communication device received within said cradle.

14. The charger of claim 12, further including a display means for incrementally displaying charging status of the Bluetooth communication device.

15. The charger, according to claim 12, wherein said at least one set of first electrical conductors includes three elongated electrical conductors.

16. The charger, according to claim 15, wherein a middle one of said three elongated electrical conductors is disposed in a plane offset from a plane of remaining two elongated electrical conductors.

17. The charger of claim 1, further including a member secured to an exterior surface of said rear wall of said pouch, said member dimensioned and shaped so at to attach said pouch to one of a limb, article of clothing, clothing accessory and carrying bag.

18. In combination with an electronic device having a rechargeable battery a charger comprising:
(a) a pouch having each of a front wall, a rear wall, a pair of side walls and a bottom wall defining in combination a hollow interior and an open end disposed in operative communication with said hollow interior, said pouch manufactured from at least one of a shock resistant and liquid impermeable material;
(b) a flap attached to or formed integral with a free edge of one wall of said pouch in operative positioning with said open end, said flap pivotal between a first position for at least partially closing said open end and an open position for opening said open end;
(c) means for releaseably securing said flap in said first position;
(d) a member secured to an exterior surface of said rear wall of said pouch, said member dimensioned and shaped so at to attach said pouch to one of a limb, article of clothing, clothing accessory and carrying bag;
(e) a generally closed chamber disposed adjacent at least one wall of said pouch;
(f) a first battery disposed within said generally closed chamber;
(g) a second battery disposed within said generally closed chamber, said second battery electrically coupled to said first battery;
(h) a power input port disposed within said generally closed chamber and accessible for entry from an exterior of said pouch;
(i) a charging circuit electrically coupled to said power input port and to at least one of said first and second batteries;
(j) a power output port disposed within said generally closed chamber and accessible for entry from said exterior of said pouch;
(k) at least one set of first electrical conductors provided for access within said hollow interior or said exterior of said pouch and electrically coupled to said charging circuit;
(l) at least one contact assembly having each of a body, a set of second electrical conductors sized and shaped to operatively and releaseably mate with said at least one set of first electrical conductors, and a power plug extending above a surface of said body, said power plug electrically coupled to said set of second electrical conductors and sized and shaped to operatively engage a power socket of the mobile electronic device, said at least one contact assembly is dimensioned so that when said sets of first and second electrical conductors are operatively mated therebetween said power plug is positioned to operatively engage he power socket of the mobile electronic device;
(m) an audio circuit having means for generating vibration;
(n) a control circuit;
(o) means for annunciating charged condition of the mobile electronic device;
(p) a first circuit having a display means for incrementally displaying charging status of the mobile electronic device;
(q) a cradle disposed on an exterior surface of one wall of said pouch, said cradle sized and shaped to receive therein a hands-free communication device operating on a Bluetooth protocol;
(r) means for charging the Bluetooth communication device received within said cradle; and
(s) a second circuit having display means for incrementally displaying charging status of the Bluetooth communication device.

19. In combination with an electronic device having a rechargeable battery a charger comprising:
(a) a pouch having each of a front wall, a rear wall, a pair of side walls and a bottom wall defining in combination a hollow interior and an open end disposed in operative communication with said hollow interior, said pouch manufactured from at least one of a shock resistant and liquid impermeable material;
(b) a flap attached to or formed integral with a free edge of one wall of said pouch in operative positioning with said open end, said flap pivotal between a first position for at least partially closing said open end and an open position for opening said open end;
(c) means for releaseably securing said flap in said first position;
(d) a member secured to an exterior surface of said rear wall of said pouch, said member dimensioned and shaped so at to attach said pouch to one of a limb, article of clothing, clothing accessory and carrying bag;
(e) a generally closed chamber disposed adjacent at least one wall of said pouch;
(f) a first battery disposed within said generally closed chamber;
(g) a second battery disposed within said generally closed chamber, said second battery electrically coupled to said first battery;
(h) a power input port disposed within said generally closed chamber and accessible for entry from an exterior of said pouch;
(i) a charging circuit electrically coupled to said power input port and to at least one of said first and second batteries;
(j) a power output port disposed within said generally closed chamber and accessible for entry from said exterior of said pouch;
(k) a predetermined plurality of first electrical conductor sets, wherein a first portion of said predetermined plurality of first electrical conductor sets is disposed for access within said hollow interior and wherein a second portion of said predetermined plurality of first electrical conductor sets is disposed for access on at least one exterior surface of said pouch;
(l) at least one contact assembly having each of a body, a set of second electrical conductors sized and shaped to operatively and releaseably mate with said at least one set of first electrical conductors, and a power plug extending above a surface of said body, said power plug electrically coupled to said set of second electrical conductors and sized and shaped to operatively engage a power socket of the mobile electronic device;
(m) an audio circuit having means for generating vibration;
(n) a control circuit;
(o) means for annunciating charged condition of the mobile electronic device;
(p) a first circuit having a display means for incrementally displaying charging status of the mobile electronic device;
(q) a cradle disposed on an exterior surface of one wall of said pouch, said cradle sized and shaped to receive therein a hands-free communication device operating on a Bluetooth protocol;
(r) means for charging the Bluetooth communication device received within said cradle; and
(s) a second circuit having display means for incrementally displaying charging status of the Bluetooth communication device.
